(19) United States
(12) Patent Application Publication
(10) Pub. No.: US 2010/0131718 A1
(43) Pub. Date: May 27, 2010

(54) MULTIPROCESSOR SYSTEM

(76) Inventors: Masato Uchiyama, Kawasaki-shi (JP); Shuou Nomura, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/557,773

(22) Filed: Sep. 11, 2009

(30) Foreign Application Priority Data
Nov. 26, 2008 (JP) 2008-301297

(51) Int. Cl. G06F 12/08

(52) U.S. Cl. 711/144; 711/E12.037

(57) ABSTRACT

A multiprocessor system includes cache systems arranged in correspondence with processor cores, and each including a cache memory which stores a cache line, a shared memory shared by the processor cores, and an arbiter configured to arbitrate access requests sent from the cache systems to the shared memory, and configured to send the arbitrated access request to the shared memory and the cache systems. The cache system includes a determination circuit configured to determine an access state using line information and the access request sent from the arbiter, a flag circuit configured to set a flag for each cache line based on a determination result of the determination circuit, and a control circuit configured to confirm the flag when a read access or a write access is made to a cache line held in the cache memory, and configured to detect a violation access based on the flag.

### CROSS-REFERENCE TO RELATED APPLICATIONS

This application is based upon and claims the benefit of priority from prior Japanese Patent Application No. 2008-301297, filed Nov. 26, 2008, the entire contents of which are incorporated herein by reference.

### BACKGROUND OF THE INVENTION

1. Field of the Invention

The present invention relates to a multiprocessor system and, more particularly, to a multiprocessor system which includes a plurality of processor cores and a shared memory which is shared by the processor cores.

2. Description of the Related Art

In recent years, development of a multiprocessor system in which a plurality of processor cores are connected via a shared bus has advanced since it is seen as a way to dramatically improve the processing performance of computers. While processor core operating frequency tends to rise year on year, increases in the speed of external memory (shared memory) have failed to keep pace. Hence, to bridge the resulting performance gap, it is common practice to use a cache memory. As a cache mechanism of such processor core, the processor core incorporates a primary cache.

A reference (Jpn. Pat. Appln. KOKAI Publication No. 2008-250373) discloses a shared memory multiprocessor system. More specifically, this reference discloses a debug system which detects an inadequate memory access so as to maintain coherency, and transfers this detection result to storage or respective processor cores by interrupts.

In the debug system, when another processor core makes a write access to a cache line which is held in a primary cache of a certain processor core in a non-rewrite (non-dirty) state, even when the contents of the rewritten cache line in the primary cache are not used in practice (=not to fail to maintain coherency as a program), the write access by the other processor core is detected as a violation access.

In order to avoid this violation detection, all the cache lines rewritten by other processor cores have to be invalidated although it is understood that these cache lines are not used after they are rewritten, and such invalidation processing which is not always required upon implementation of processing prolongs a processing time.

In a situation that a large data area is shared by a plurality of processor cores, and in a situation that a synchronization timing restriction is not strict, when a certain processor core executes processing for rewriting only some data, that processor core has to execute synchronization processing, i.e., it waits for completion of invalidation processing by informing other processor cores of an area to be rewritten before that area is rewritten, although that processor core need only request another processor core to designate and re-load that area after the area is rewritten under normal conditions. As a result, the processing time is prolonged.

### BRIEF SUMMARY OF THE INVENTION

According to an aspect of the present invention, there is provided a multiprocessor system comprising: a plurality of cache systems arranged in correspondence with a plurality of processor cores, and each including a cache memory which stores a cache line as a processing unit of data; a shared memory shared by the processor cores; and an arbiter configured to arbitrate access requests sent from the cache systems to the shared memory, and configured to send the arbitrated access request to the shared memory and the cache systems. The cache line includes line information which includes a valid bit indicating whether or not the cache line is valid, a dirty bit indicating whether or not the cache line is written back to the shared memory, and a tag as address information of the cache line. Each of the cache systems includes: a determination circuit configured to determine an access state using the line information and the access request sent from the arbiter; a flag circuit configured to set a flag for each cache line based on a determination result of the determination circuit; and a control circuit configured to confirm the flag when a read access or a write access is made to a cache line held in the cache memory, and configured to detect a violation access based on the flag.

According to an aspect of the present invention, there is provided a multiprocessor system comprising: a plurality of cache systems arranged in correspondence with a plurality of processor cores, and each including a cache memory which stores a cache line as a processing unit of data; a shared memory shared by the processor cores; and an arbiter configured to arbitrate access requests sent from the cache systems to the shared memory, and configured to send the arbitrated access request to the shared memory and the cache systems. The cache line includes line information which includes a valid bit indicating whether or not the cache line is valid, a dirty bit indicating whether or not the cache line is written back to the shared memory, a tag as address information of the cache line, and a flag used to determine a violation access. Each of the cache systems includes: a determination circuit configured to determine an access state using the line information and the access request sent from the arbiter; a flag circuit configured to set the flag based on a determination result of the determination circuit; and a control circuit configured to confirm the flag when a read access or a write access is made to a cache line held in the cache memory, and configured to detect the violation access based on the flag.

According to an aspect of the present invention, there is provided a multiprocessor system comprising: a plurality of cache systems arranged in correspondence with a plurality of processor cores, and each including a cache memory which stores a cache line as a processing unit of data; a shared memory shared by the processor cores; and an arbiter configured to arbitrate access requests sent from the cache systems to the shared memory, and configured to send the arbitrated access request to the shared memory and the cache systems. The cache line includes line information which includes a valid bit indicating whether or not the cache line is valid, a dirty bit indicating whether or not the cache line is written back to the shared memory, and a tag as address information of the cache line. Each of the cache systems includes: a determination circuit configured to determine an access state using the line information and the access request sent from the arbiter; a first control circuit configured to temporarily rewrite a valid bit and a dirty bit so as to use the valid bit and the dirty bit as a flag indicating a determination result of the determination circuit; and a second control circuit configured to confirm the flag when a read access or a write access is made to a cache line held in the cache memory, and configured to detect a violation access based on the flag.

### BRIEF DESCRIPTION OF THE SEVERAL VIEWS OF THE DRAWING

FIG. 1 is a block diagram showing the arrangement of a multiprocessor system 10 according to the first embodiment of the present invention;

FIG. 2 is a block diagram showing the arrangement of a cache system 21;

FIG. 3 is a schematic view showing the configuration of a primary cache memory 22;

FIG. 4 is a block diagram showing the arrangement of a violation detection circuit 24;

FIG. 5 is a block diagram showing the arrangement of an incoherence flag control circuit 25;

FIG. 6 is a block diagram showing the arrangement of a violation processing circuit 16;

FIG. 7 is a block diagram showing the arrangement of a cache system 21 according to the second embodiment of the present invention;

FIG. 8 is a schematic view showing the configuration of a primary cache memory 22;

FIG. 9 is a block diagram showing the arrangement of an incoherence flag control circuit 25; and

FIG. 10 is a block diagram showing the arrangement of an incoherence flag control circuit 25 according to the third embodiment of the present invention.

### DETAILED DESCRIPTION OF THE INVENTION

The embodiments of the present invention will be described hereinafter with reference to the accompanying drawings. In the description which follows, the same or functionally equivalent elements are denoted by the same reference numerals, to thereby simplify the description.

### First Embodiment

[1. Arrangement of Multiprocessor System 10]

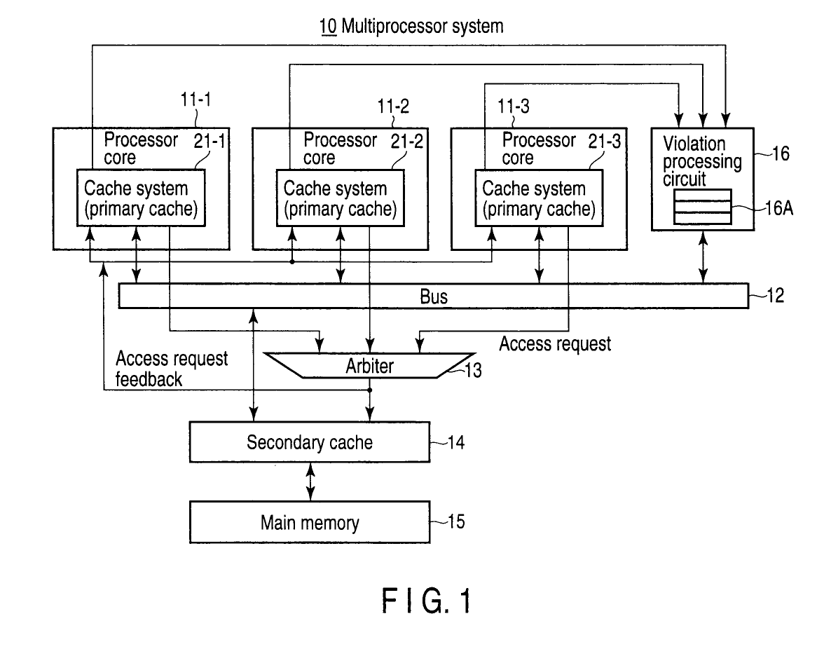

FIG. 1 is a block diagram showing the arrangement of a multiprocessor system 10 according to the first embodiment of the present invention. The multiprocessor system 10 shown in FIG. 1 is configured as, for example, a system large-scale integration (LSI) circuit formed on a chip.

The multiprocessor system 10 includes a plurality of processor cores 11, an arbiter 13, a secondary cache memory (secondary cache) 14 used as a shared memory, a main memory 15, and a violation processing circuit 16. In this embodiment, three processor cores 11-1 to 11-3 are exemplified, but the number of processor cores is not limited. In the following description, when the plurality of processor cores 11 need not be distinguished from each other, each processor core will be simply denoted by “11”. The same applies to circuits included in the processor cores 11. The secondary cache 14 is configured by, for example, a static random access memory (SRAM). The main memory 15 is configured by, for example, a dynamic random access memory (DRAM).

Each processor core 11 accesses the main memory 15 via a bus 12 and the secondary cache 14. Note that in this embodiment, the secondary cache 14 as the shared memory is not always required, and each processor core 11 may directly access the main memory 15 as the shared memory via the bus 12.

The arbiter 13 arbitrates contentions of access requests from processor cores 11-1 to 11-3 to the secondary cache 14. That is, when accesses from the plurality of processor cores to the shared memory contend via the bus 12, the arbiter 13 performs access assignment by a prescribed method. Then, only one access request per cycle is sent to the secondary cache 14. An access request that does not hit the secondary cache 14 is sent to the main memory 15.

An access request sent from each processor core 11 to the secondary cache 14 includes a primary cache write identification signal CWI in addition to information such as a processor core number, read/write identification signal, secondary cache direct access identification signal, primary cache refill access identification signal, and access destination address. The primary cache write identification signal CWI will be described later. The read/write identification signal is a signal used to identify a read/write operation. The secondary cache direct access identification signal is a signal used to identify an operation to access the shared memory without going through a primary cache. The primary cache refill access identification signal is a signal used to identify an operation to replace data in the shared memory by data in the primary cache at the time of a cache miss.

As shown in FIG. 1, the multiprocessor system 10 of this embodiment includes a feedback path used to feed back an access request sent to the secondary cache 14 to each processor core 11. Each processor core 11 can confirm the access contents of other processor cores using this access request feedback. Also, a violation access can be detected using the access request feedback.

Each processor core 11 is a central processing unit (CPU) required to control the operation of the multiprocessor system 10, and controls a cache memory and other circuits by executing a program stored in the main memory 15 and the like. Then, the LSI segments the contents to be processed into a plurality of tasks, and controls the processor cores having arrangements optimal to respective tasks to operate parallelly, thus greatly improving the processing speed. Processor cores 11-1 to 11-3 respectively include cache systems 21-1 to 21-3 as primary caches.

[2. Arrangement of Cache System 21]

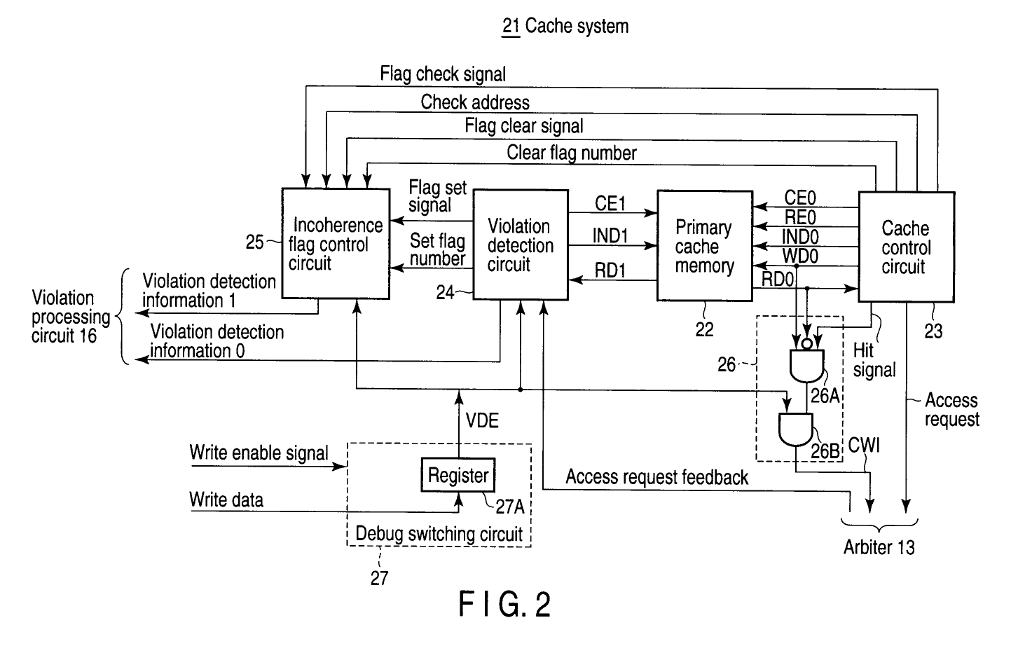

FIG. 2 is a block diagram showing the arrangement of the cache system 21 as the primary cache. Note that FIG. 2 illustrates one cache system 21 included in one processor core 11, and the arrangements of the cache systems 21 included in other processor cores 11 are the same as that shown in FIG. 2.

The cache system 21 includes a primary cache memory 22, cache control circuit 23, violation detection circuit 24, incoherence flag control circuit 25, dirty transition detection circuit 26, and debug switching circuit 27. In this embodiment, the violation detection circuit 24, incoherence flag control circuit 25, dirty transition detection circuit 26, debug switching circuit 27, and violation processing circuit 16 configure a debug circuit.

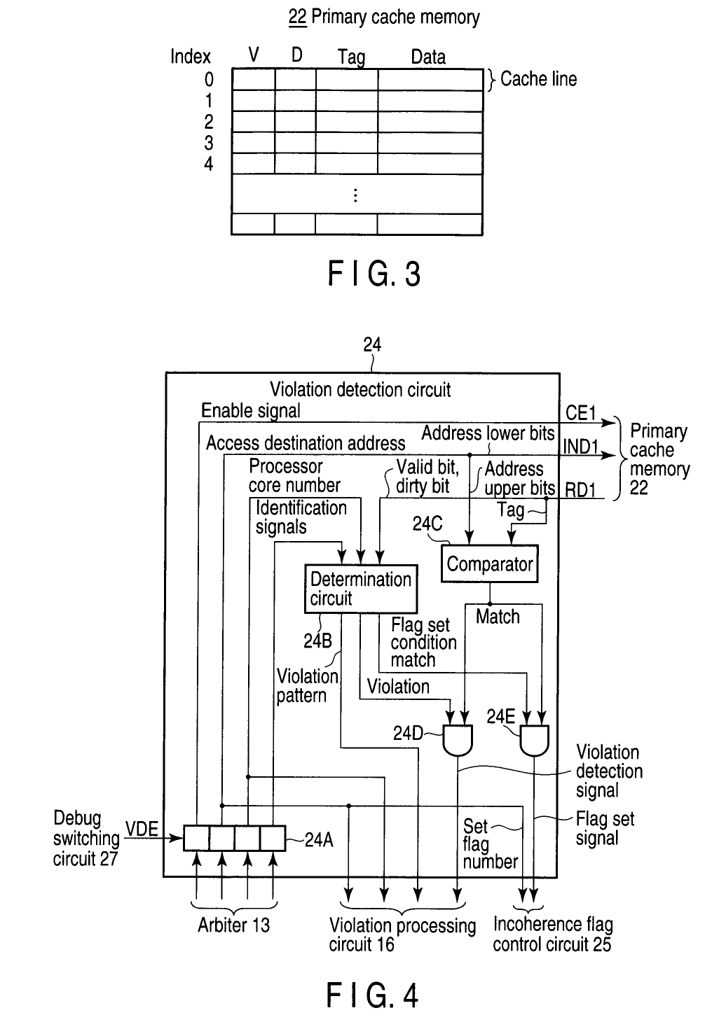

The primary cache memory 22 is configured by, for example, an SRAM. FIG. 3 is a schematic view showing the configuration of the primary cache memory 22. The primary cache memory 22 includes areas for storing cache lines including a plurality of data. This cache line is a unit of data exchanged between the cache and shared memory at the time of access, and corresponds to data for one line in FIG. 3.

Furthermore, the primary cache memory 22 includes fields for respectively storing a valid bit (V), dirty bit (D), tag, and data. The valid bit, dirty bit, and tag are appended for each cache line. An index represents the number of a cache line, and is used to select a cache line. That is, indices defined by numbers starting from 0 are given to respective cache lines in turn from the uppermost cache line. The tag indicates address information of each cache line.

The valid bit indicates whether or not a cache line is valid. That is, the valid bit indicates whether or not a cache line in the primary cache memory 22 is valid as data expressed by the index and tag of this cache line. When the valid bit=1, that cache line is valid; when the valid bit=0, that cache line is invalid.

The dirty bit indicates whether or not a cache line in the primary cache memory 22 is rewritten (updated) and is written back to the shared memory. Since data written in the primary cache memory 22 by the processor core has to be written back to the shared memory (to make a write-back access), the dirty bit indicating whether or not data is written back to the shared memory is allocated for each cache line. In other words, the dirty bit indicates that a cache line of the primary cache memory stores latest data since it is rewritten, the shared memory as a copy source of this cache line stores only old data, and the rewritten processor core possesses the latest data. The dirty bit is set to “1” when a cache line is updated, and is not written back to the shared memory yet.

As shown in FIG. 2, the primary cache memory 22 has two access ports (access port 0 and access port 1). The valid bit, dirty bit, and tag stored in the primary cache memory 22 are simultaneously read for each cache line. An access using access port 0 is made by a chip enable signal CE0, and that using access port 1 is made by a chip enable signal CE1.

The cache control circuit 23 accesses the primary cache memory 22 using access port 0. More specifically, at the time of a write access, the cache control circuit 23 asserts chip enable signal CE0, and sends an index IND0 and write data WD0 to the primary cache memory 22. Then, write data WD0 is written in a cache line corresponding to index IND0. Also, at the time of a read access, the cache control circuit 23 asserts a read enable signal RE0, and sends index IND0 to the primary cache memory 22. Then, the cache control circuit 23 receives a cache line corresponding to index IND0 from the primary cache memory 22 as read data RD0.

The cache control circuit 23 generates a cache hit signal indicating whether or not data hits the primary cache memory 22, and sends this cache hit signal to the dirty transition detection circuit 26. This cache hit signal is set to “1” at the time of a cache hit or “0” at the time of a cache miss.

The cache control circuit 23 writes data to the primary cache memory 22 in the following two cycles.

Cycle 1: read valid bit, dirty bit, and tag

Cycle 2: determine cache hit/miss

Then, the cache control circuit 23 writes data to the primary cache memory 22 at the time of a cache hit. On the other hand, at the time of a cache miss, the cache control circuit 23 makes a refill access to the secondary cache 14. Note that “refill” is processing for replacing a cache line of the primary cache memory 22 by data of the secondary cache 14 at the time of a cache miss.

In addition to these operations, the cache control circuit 23 executes check control and clear control of an incoherence flag with respect to the incoherence flag control circuit 25. These operations will be described later.

The debug switching circuit 27 sets validity or invalidity of violation access detection by the debug circuit arranged in the processor core. The debug switching circuit 27 includes a 1-bit register 27A, and sets validity or invalidity of violation access detection based on data in this register 27A. The data in the register 27A is set as follows.

1′b1: violation access detection valid

1′b0: violation access detection invalid

Note that “1′b” indicates a 1-bit binary value.

The data in the register 27A can be freely rewritten by a write enable signal and write data which are externally supplied via the bus 12. The data in the register 27A is always output, and is sent to the violation detection circuit 24, incoherence flag control circuit 25, and dirty transition detection circuit 26 as a violation detection enable signal VDE.

The dirty transition detection circuit 26 includes a 3-input AND gate 26A and 2-input AND gate 26B. AND gate 26A receives dirty bit write data (WD0), dirty bit read data (RD0), and a cache hit signal. AND gate 26B receives an output from AND gate 26A and the violation detection enable signal VDE.

The dirty transition detection circuit 26 with the arrangement shown in FIG. 2 determines that the dirty bit is rewritten from 0 to 1 when the following conditions are met, and sets the primary cache write identification signal CWI to “1”.

Violation detection enable VDE=1

Cache hit signal=1

Dirty bit write data=1

Dirty bit read data=0

The dirty transition detection circuit 26 determines using a dirty bit read in the first cycle and that to be written (updated) in the second cycle whether or not the dirty bit is rewritten from “0” to “1”, and outputs this determination result as the primary cache write identification signal CWI. That is, the primary cache write identification signal CWI is a signal used to identify an operation in which a cache line in the primary cache memory 22 is rewritten by new data after the cache line in the primary cache memory 22 is replaced by data in the secondary cache 14. The dirty transition detection circuit 26 outputs the primary cache write identification signal CWI when the violation detection enable signal VDE is asserted. This primary cache write identification signal CWI is sent to the arbiter 13.

At this time, as in the case of a cache miss, an access request other than the primary cache write identification signal CWI is sent from the processor core 11 to the arbiter 13 via the cache control circuit 23. When the primary cache write identification signal CWI is asserted, both the secondary cache direct access identification signal and primary cache refill access identification signal are set to “0”. That is, an access request sent from the cache control circuit 23 to the arbiter 13 is set as follows.

Processor core number=self core number

Read/write identification signal=0 (read)

Secondary cache direct access identification signal=0

Primary cache refill access identification signal=0

Access destination address=access destination address of shared memory

Note that when the violation detection enable signal VDE is negated (i.e., when violation access detection is invalid), the primary cache write identification signal CWI is fixed to “0” by AND gate 26B. This case is the same as normal cache access processing, and an access request other than the primary cache write identification signal CWI remains unchanged from that at the time of the normal cache access processing.

[2-1. Arrangement of Violation Detection Circuit 24]

The violation detection circuit 24 accesses the primary cache memory 22 using access port 1. More specifically, the violation detection circuit 24 asserts a chip enable signal CE1, and sends an index IND1 to the primary cache memory 22. As a result, the violation detection circuit 24 receives a cache line corresponding to index IND1 from the primary cache memory 22 as read data RD1. Also, the violation detection circuit 24 receives an access request from the arbiter 13 via the feedback path. The violation detection circuit 24 operates only when the violation detection enable signal VDE is asserted, and ignores the access request from the arbiter 13 when the violation detection enable signal VDE is negated.

FIG. 4 is a block diagram showing the arrangement of the violation detection circuit 24. The violation detection circuit 24 includes a register 24A, determination circuit 24B, comparator 24C, and two AND gates 24D and 24E.

The register 24A stores an access request sent from the arbiter 13. The access request stored in the register 24A includes an enable signal asserted at the time of the access request, an access destination address, a processor core number, and identification signals. The processor core number and identification signals are sent to the determination circuit 24B. The enable signal is sent to the primary cache memory 22 as chip enable signal CE1. Upper bits of the access destination address correspond to a tag, and lower bits thereof correspond to an index. Hence, the address upper bits are sent to the comparator 24C, and the address lower bits are sent to the primary cache memory 22 as index IND1.

Of the read data RD1 read based on chip enable signal CE1 and index IND1, a valid bit and dirty bit are sent to the determination circuit 24B, and a tag is sent to the comparator 24C.

The comparator 24C compares the tag read from the primary cache memory 22 and that included in the access request, and determines whether or not they indicate an identical address.

The determination circuit 24B processes the valid bit and dirty bit read from the primary cache memory 22 together with the processor core number and identification signals (read and write secondary cache direct access identification signals, read and write primary cache refill access identification signals, and primary cache write identification signal CWI), and determines based on a predetermined policy whether or not that access pattern is a violation. The determination circuit 24B executes violation access detection every time the data in the register 24A and the read data RD1 from the primary cache memory 22 are updated.

An example of the violation access detection policy will be described below. In this embodiment, the following five access patterns are detected as violations. Note that “cache line” to be referred to in the following description generally indicates cache lines with the same address.

(1) A first access pattern: another processor core makes a read access to a cache line including a valid bit=1 and a dirty bit=1 (the processor core which made the read access reads non-latest data).

(2) A second access pattern: another processor core makes a write access to a cache line including a valid bit=1 and a dirty bit=1 (it cannot be decided which of the write result to the primary cache memory by the processor core which holds the cache line and that to the secondary cache by the other processor core is finally reflected).

(3) A third access pattern: a processor core itself, which holds a cache line including a valid bit=1 and a dirty bit=1, makes a secondary cache direct read access to that cache line (since the latest data is stored in the primary cache memory of the processor core itself, data read from the second cache is not the latest one).

(4) A fourth access pattern: a processor core itself, which holds a cache line including a valid bit=1 and a dirty bit=1, makes a secondary cache direct write access to that cache line (it cannot be decided which of the write result to the primary cache memory by the processor core which holds the cache line and that to the secondary cache by that processor core is finally reflected).

(5) A fifth access pattern: after a first processor core, which holds a cache line including a valid bit=1 and a dirty bit=0, makes a secondary cache direct write access to that cache line, or after another second processor core makes a write access to the primary cache memory or secondary cache, the first processor core itself makes a read or write access to that cache line held in the primary cache memory of itself (that processor core uses non-latest data).

The determination circuit 24B determines whether or not an access included in a part of the fifth violation access pattern 5 is a pattern for which an incoherence flag is to be set, in addition to determination of the four violation access patterns 1 to 4. A pattern for which the incoherence flag is to be set corresponds to a pattern in which “a first processor core, which holds a cache line including a valid bit=1 and a dirty bit=0, makes a secondary cache direct write access to that cache line”, and a pattern in which “a second processor core different from the first processor core makes a write access to a cache line including a valid bit=1 and a dirty bit=0 of the primary cache memory or secondary cache”.

Because, when such access is made, the cache line of the first processor core, which holds that cache line, stores non-latest data. However, no problem is especially posed when the cache line of this first processor core is not used later. Hence, at the time of detection of the above two access patterns, a violation is not immediately determined, and an incoherence flag is temporarily set. Then, a violation access is determined when the first processor core uses the non-latest cache line. That is, the incoherence flag is used to identify whether or not the cache line held by the first processor core has already been rewritten by the other second processor core.

Each individual access pattern does not correspond to only one violation, and similar illegal access patterns may be generated by various violations. For example, when processor core 11-2 generates an access to a cache line including a valid bit=1 and a dirty bit=1 in processor core 11-1, and when that cache line is included in an area where processor core 11-1 is permitted to make a rewrite access but processor core 11-2 is inhibited from accessing, the access of processor core 11-2 becomes an illegal access. Conversely, the access of processor core 11-2 is legal, but processor core 11-1 holds a cache line including a valid bit=1 and a dirty bit=1 since it previously made a write access to an area where it was not permitted to make a write access. This access pattern may be illegal.

Note that the definitions of violation accesses may be different depending on systems and use purposes, and the detection policies of violation accesses have to be changed accordingly. In this case, as described above, one violation access pattern is likely to include a plurality of causes. Therefore, the detection policies are set so that each violation access pattern corresponds to any of detection policies. In this manner, detection errors of violation accesses are prevented.

[2-2. Arrangement of Incoherence Flag Control Circuit 25]

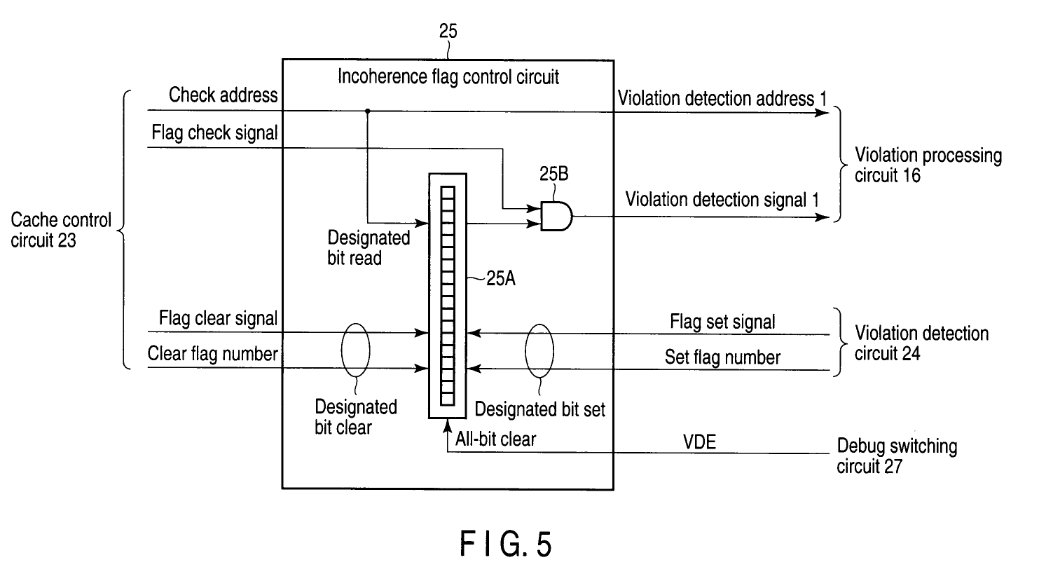

FIG. 5 is a block diagram showing the arrangement of the incoherence flag control circuit 25. The incoherence flag control circuit 25 includes a register 25A having the number of bits corresponding to the number of cache lines in the primary cache memory 22, and one AND gate 25B.

The incoherence flag control circuit 25 receives a flag set signal and set flag number from the violation detection circuit 24. In response to these signals, the incoherence flag control circuit 25 executes designated bit set processing.

Also, the incoherence flag control circuit 25 receives a flag check signal, check address, flag clear signal, and clear flag number from the cache control circuit 23. In response to these signals, the incoherence flag control circuit 25 executes designated bit clear processing. Upon reception of the flag check signal, the incoherence flag control circuit 25 executes designated bit read processing.

The incoherence flag control circuit 25 receives the violation detection enable signal VDE from the debug switching circuit 27. When the violation detection enable signal VDE is negated, the incoherence flag control circuit 25 clears all the bits of the register 25A.

When a read or write access to the primary cache memory 22 is generated, the incoherence flag control circuit 25 confirms the contents of a flag read by the designated bit read processing. When this flag is set, the incoherence flag control circuit 25 determines that the current access is a violation access. This determination result is sent to the violation processing circuit 16 as violation detection signal 1.

[2-3. Arrangement of Violation Processing Circuit 16]

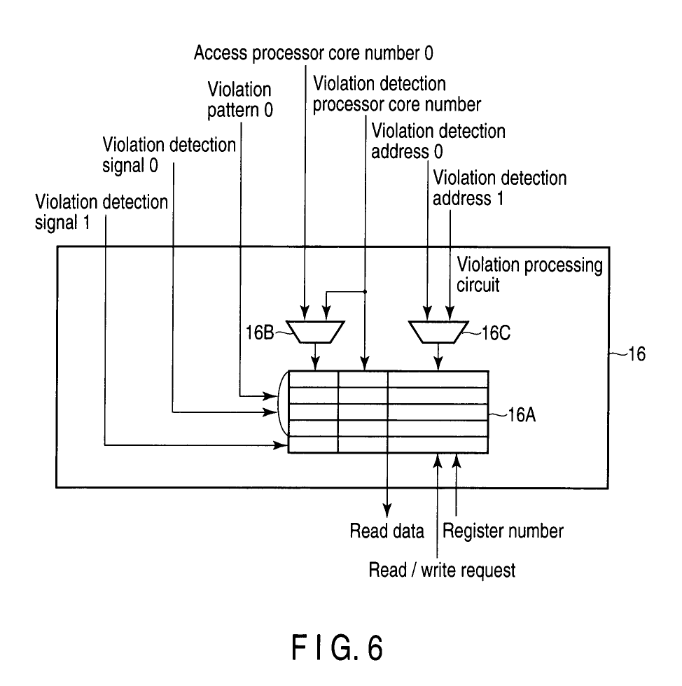

FIG. 6 is a block diagram showing the arrangement of the violation processing circuit 16. The violation processing circuit 16 includes a violation information register 16A, and two selectors 16B and 16C. This violation information register 16A includes registers as many as the number of violation access patterns (the aforementioned five access patterns in this embodiment).

The violation processing circuit 16 receives violation detection information 0 from the violation detection circuit 24, and violation detection information 1 from the incoherence flag control circuit 25. Violation detection information 0 includes violation detection signal 0, violation pattern 0, access processor core number 0, and violation detection address 0. Violation detection information 1 includes violation detection signal 1 and violation detection address 1.

When the violation detection circuit 24 included in each of processor cores 11-1 to 11-3 detects a violation access and asserts a violation detection signal, the violation processing circuit 16 writes and holds the processor core number and detection address in a register designated by violation access pattern.

When violation detection signal 0 is asserted, the violation processing circuit 16 writes access processor core number 0, violation detection processor core number, and violation detection address 0 to a register corresponding to violation detection pattern 0.

When violation detection signal 1 is asserted, the violation processing circuit 16 writes, to a register corresponding to violation detection signal 1, violation detection processor core number, violation detection address 1, and violation detection processor core number as the number of the processor core which detected the violation. As the violation detection processor core number, the number of a processor core having the primary cache is input to the violation processing circuit 16 as a circuital fixed value.

These pieces of violation information stored in the violation information register 16A can be externally read via the bus. That is, when a read request and register number are externally sent to the violation processing circuit 16, violation information of an area corresponding to the register number in the violation information register 16A is externally read as read data via the bus. The read violation information is used in debugging in the multiprocessor system 10.

[3. Operation of Multiprocessor System 10]

The operation of the multiprocessor system 10 with the aforementioned arrangement will be described below.

The operation of the violation detection circuit 24 will be described first. At the time of detection of a violation access, the debug switching circuit 27 asserts the violation detection enable signal VDE.

As shown in FIG. 4, the violation detection circuit 24 receives an access request (including an enable signal, processor core number, access destination address, read/write identification signal, secondary cache direct access identification signal, primary cache refill access identification signal, and primary cache write identification signal CWI) arbitrated by the arbiter 13 via the feedback path. When the violation detection enable signal VDE is asserted, the violation detection circuit 24 stores the access request in the register 24A.

Then, the violation detection circuit 24 sends the enable signal stored in the register 24A to the primary cache memory 22 as chip enable signal CE1, and lower bits of the access destination address to the primary cache memory 22 as index IND1. As a result, the violation detection circuit 24 receives a valid bit, dirty bit, and tag of a cache line corresponding to index IND1 from the primary cache memory 22 as the read data RD1.

Then, the comparator 24C compares the tag read from the primary cache memory 22 and the upper bits (tag) of the access destination address from the arbiter 13 to determine if they indicate an identical cache line. If the two tags match, the comparator 24C asserts a match signal, and sends it to AND gates 24D and 24E.

The determination circuit 24B processes the valid bit and dirty bit read from the primary cache memory 22 together with the processor core number and identification signals to determine based on the aforementioned detection policies whether or not that access pattern is a violation access. Furthermore, the determination circuit 24B determines whether or not the access pattern is that for which an incoherence flag is to be set.

When the access pattern is the aforementioned pattern for which an incoherence flag is to be set (flag set conditions are met), and the access destination is the same as the cache line held in the processor core, the violation detection circuit 24 sets an incoherence flag. That is, the violation detection circuit 24 asserts a flag set signal, and sends the index included in the access destination address to the incoherence flag control circuit 25 as a set flag number.

When the access pattern corresponds to one of the aforementioned violation accesses 1 to 4, the determination circuit 24B asserts a violation signal and sends it to AND gate 24D. When the access pattern is a violation access, and the access destination is the same as the cache line held in the processor core, a violation access is detected. In this case, the violation detection circuit 24 sends the detection result (violation detection signal 0), a violation pattern (violation detection pattern 0), the number of a processor core which made an access as a cause of the violation detection (access processor core number 0), and the access destination address (violation detection address 0) to the violation processing circuit 16. In this way, the violation detection circuit 24 detects one of the violation accesses 1 to 4.

The operation of the cache control circuit 23 will be described below. When a read access or write access which hits a cache line held in the primary cache memory 22 is made, the cache control circuit 23 asserts a flag check signal used to check the incoherence flag, and sends an address where the read or write access was made to the incoherence flag control circuit 25 as a check address.

When the state of a cache line held in the primary cache memory 22 is changed to one of states 1 to 3 below, the cache control circuit 23 asserts a flag clear signal used to clear the incoherence flag, and sends the index of this cache line to the incoherence flag control circuit 25 as a clear flag number.

(1) a state in which a new cache line is overwritten on the held cache line by the refill processing

(2) a state in which a new cache line is overwritten on the held cache line by a cache line allocation operation without refill

(3) a state in which the held cache line is invalidated by a direct rewrite operation of the primary cache memory

The operation of the incoherence flag control circuit 25 will be described below. The incoherence flag control circuit 25 sets and clears the incoherence flag as follows.

When the violation detection circuit 24 detects the access pattern for which the incoherence flag is to be set, it asserts the flag set signal. As shown in FIG. 5, when the flag set signal is asserted, the incoherence flag control circuit 25 executes designated bit set processing. That is, the incoherence flag control circuit 25 sets a flag in a bit of the register 25A corresponding to the set flag number (sets “1” in that bit).

When the cache control circuit 23 detects a state change of a cache line for which the incoherence flag is to be cleared, it asserts the flag clear signal. When the flag clear signal is asserted, the incoherence flag control circuit 25 executes designated bit clear processing. That is, the incoherence flag control circuit 25 clears a flag of the register 25A corresponding to the clear flag number (sets “0” in a corresponding bit).

The incoherence flag control circuit 25 performs violation detection corresponding to violation access pattern 5 as follows.

When the cache control circuit 23 detects an access to a cache line, the incoherence flag of which is to be checked, it asserts the flag check signal. In response to this, the incoherence flag control circuit 25 executes designated bit read processing. That is, the incoherence flag control circuit 25 confirms the contents of a flag of the register 25A corresponding to the check address. Then, when this incoherence flag is set, the incoherence flag control circuit 25 determines that the current access corresponds to violation access pattern 5, and asserts violation detection signal 1. The incoherence flag control circuit 25 sends the check address sent from the cache control circuit 23 as violation detection address 1 to the violation processing circuit 16 together with violation detection signal 1.

On the other hand, when this incoherence flag is cleared, the incoherence flag control circuit 25 determines that the current access does not correspond to violation access pattern 5. In this case, the incoherence flag control circuit 25 does not output any violation detection information 1 to the violation processing circuit 16.

Note that a new incoherence flag is set every time the debug function is validated (every time the violation detection enable signal VDE is asserted). For this reason, when the violation detection enable signal VDE is negated, the incoherence flag control circuit 25 clears all the bits (all the flags) of the register 25A.

The aforementioned embodiment has been explained under the assumption of a cache system of a direct map [one-way] type. Of course, this embodiment is similarly applicable to a cache system of a set associative type having two or more ways. In case of the cache system having two or more ways, since the number of cache lines held by the cache system amounts to a product of the number of indices and the number of ways, the following points are different.

Upon making violation determination, sets of valid bits, dirty bits, and tags as many as the number of ways are read from the primary cache memory 22. Hence, the determination circuit 24B and comparator 24C in FIG. 4 are also copied as many as the number of ways. However, since a tag does not simultaneously match a plurality of cache lines, only one determination result is obtained.

In case of one way, the flag number of an incoherence flag equals the index of a cache line. However, the flag number in case of two or more ways is a number which is generated based on an index and way information, and indicates one cache line. The flag number is used in two locations.

the clear flag number upon clearing an incoherence flag

the set flag number upon setting an incoherence flag

Upon checking an incoherence flag, the check address is the same as that in case of one way, and the flag check signal has the same number of bits as the number of ways. An index is extracted from the check address, and is combined with information indicating a bit “1” of the flag check signal, thus deciding the number of a flag to be read.

As described in detail above, according to the first embodiment, upon detection of a predetermined violation access, a flag is temporarily set in correspondence with a cache line which is in the predetermined violation access state. The flag is confirmed when a read or write access is made to the primary cache memory, and when this flag is set, the violation access is determined. More specifically, when a first processor core which holds a cache line including a valid bit=1 and a dirty bit=0 makes a secondary cache direct write access to this cache line, or another second processor core makes a write access to the primary cache memory or secondary cache, a violation is not immediately determined at that time, and an incoherence flag is temporarily set to identify that access. After the data of the processor core which holds the cache lines becomes non-latest data as a result of the access, when that processor core makes a read or write access to the cache line, a violation access is determined.

Therefore, according to the first embodiment, when a cache line in the primary cache memory of the first processor core is not latest with respect to the contents in the secondary cache or the primary cache memory of the second processor core, and only when the first processor core uses this non-latest data in practice, that access can be detected as a violation access. Hence, compared to a case in which a violation access is detected even though the first processor core does not actually use the non-latest data, the need for extra synchronization processing and cache line invalidation processing can be obviated, thus shortening the processing time.

The incoherence flag control circuit 25 includes the register 25A which holds an incoherence flag, and the flag set signal or flag clear signal, and address are supplied to the incoherence flag control circuit 25, thereby setting or clearing the incoherence flag. In this way, the incoherence flag can be accurately and easily set or cleared, and the need for explicitly clearing the flag using a program can be obviated.

When the debug function is invalidated (when the violation detection enable signal VDE is negated), the flags in the register 25A that stores incoherence flags are simultaneously cleared. Thus, when the debug function is temporarily invalidated and is validated again, inconsistency between the cache state that has changed during the debug function invalid period and the contents of the incoherence flags can be prevented, and an erroneous operation of the debug function can be prevented.

Also, violation information detected by the violation detection circuit 24 can be stored in the violation information register 16A in the violation processing circuit 16. As a result, the violation information to be read can be freely read externally, and the processor core can be debugged using this violation information.

Since new circuits added to the multiprocessor system 10 configure the debug circuit, the function may be invalidated at the time of delivery of a product. Since power is not consumed after the function is invalidated, that function does not influence consumption power after delivery of the product even when the debug circuit which may increase signal changes and may require large consumption power is implemented.

### Second Embodiment

In the first embodiment, each incoherence flag is implemented using a dedicated memory or register. Since each incoherence flag exists in correspondence with a cache line in the primary cache memory 22, an implementation that allocates an incoherence flag as the third bit following the valid bit and dirty bit may be used. In the second embodiment, a new flag bit is prepared in the primary cache memory 22, and an incoherence flag is stored in this flag bit.

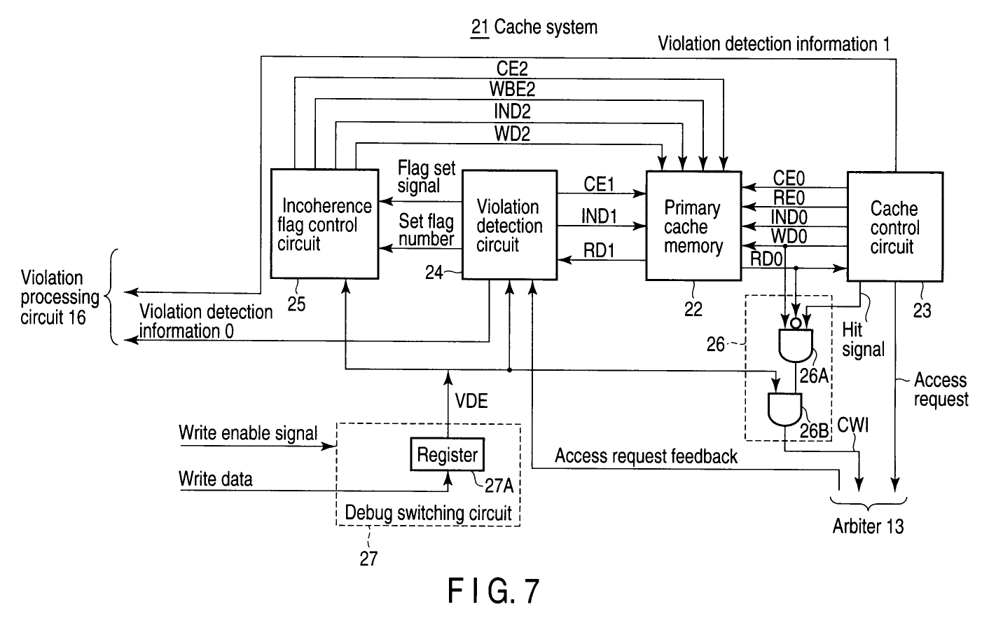

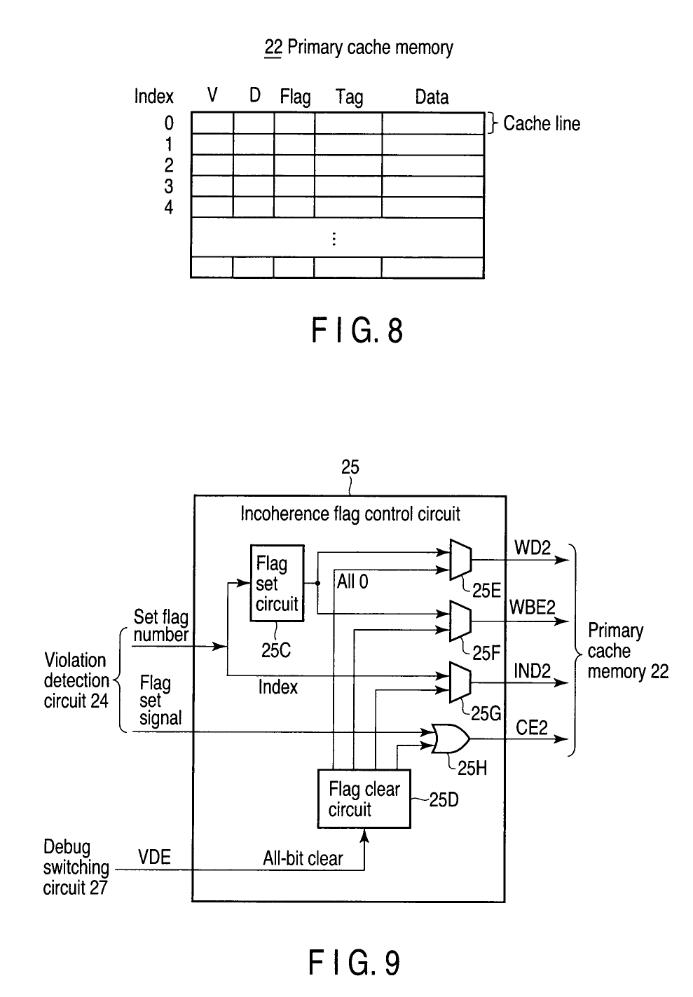

The overall arrangement of the multiprocessor system 10 is the same as the first embodiment. FIG. 7 is a block diagram showing the arrangement of a cache system 21 according to the second embodiment. FIG. 8 is a schematic view showing the configuration of a primary cache memory 22.

The primary cache memory 22 includes a field for storing an incoherence flag (flag bit) in addition to those for respectively storing a valid bit (V), dirty bit (D), tag, and data. This flag bit is allocated for each cache line.

In the first embodiment, the cache control circuit 23 executes the flag check processing and flag clear processing with respect to the incoherence flag control circuit 25. However, in the second embodiment, the cache control circuit 23 executes the flag check processing and flag clear processing with respect to the primary cache memory 22. The flag check processing and flag clear processing of the cache control circuit 23 will be described later.

FIG. 9 is a block diagram showing the arrangement of an incoherence flag control circuit 25. The incoherence flag control circuit 25 includes a flag set circuit 25C, a flag clear circuit 25D, three selectors 25E, 25F, and 25G, and an OR gate 25H.

The incoherence flag control circuit 25 receives a flag set signal and set flag number from the violation detection circuit 24. Also, the incoherence flag control circuit 25 receives a violation detection enable signal VDE from the debug switching circuit 27. The flag set signal is input to the OR gate 25H. The set flag number is input to the flag set circuit 25C and selector 25G.

The flag set circuit 25C executes processing for setting an incoherence flag in the primary cache memory 22. To attain this processing, the flag set circuit 25C generates an enable signal used to assert a flag bit of the primary cache memory 22, and data to be set in the flag bit.

The violation detection enable signal VDE is input to the flag clear circuit 25D. The flag clear circuit 25D executes processing for clearing an incoherence flag in the primary cache memory 22. To attain this processing, the flag clear circuit 25D generates an enable signal used to assert the primary cache memory 22, an enable signal used to assert a specific flag bit of the primary cache memory 22, an index of a cache line, and data used to clear the flag bit.

The incoherence flag control circuit 25 sends a chip enable signal CE2, write bit enable signal WBE2, index IND2, and write data WD2 to the primary cache memory 22. With these signals, a flag bit in the primary cache memory 22 is set or cleared.

(Operation)

The operation of the cache system 21 with this arrangement will be described below. The incoherence flag set and clear operations by the incoherence flag control circuit 25 will be described first.

When the violation detection circuit 24 detects an access pattern for which an incoherence flag is to be set, it asserts a flag set signal. When the flag set signal is asserted, the incoherence flag control circuit 25 asserts chip enable signal CE2. Upon reception of a set flag number corresponding to an index of a cache line from the violation detection circuit 24, the incoherence flag control circuit 25 sends it as index IND2 to the primary cache memory 22 together with the flag set signal.

Upon reception of the set flag number, the flag set circuit 25C sets “1” in a bit corresponding to a flag in the write bit enable signal WBE2, and sends that signal to the primary cache memory 22. The flag set circuit 25C sets “1” in a bit corresponding to the flag in write data WD2, and sends that data to the primary cache memory 22. In this way, a specific incoherence flag of the primary cache memory 22 is set.

When the debug function is invalidated (when the violation detection enable signal VDE is negated), the flag clear circuit 25D executes all-bit clear processing of flags. That is, the flag clear circuit 25D asserts chip enable signal CE2, sets “1” in a bit corresponding to each flag of the write bit enable signal WBE2 and “0” in a bit corresponding to the flag of write data WD2, and sends them to the primary cache memory 22. Then, the flag clear circuit 25D sends indices of all cache lines in turn to the primary cache memory 22 as index IND2. As a result, all the incoherence flags of the primary cache memory 22 are cleared.

In a cache system having a plurality of ways, when a plurality of incoherence flags corresponding to a plurality of cache lines exist with respect to an identical index, the write bit enable signal WBE2 and write data WD2 are set to manipulate bits corresponding to all the flags.

The operation of the cache control circuit 23 will be described below. When a read or write access that hits a cache line held in the primary cache memory 22 is made, the cache control circuit 23 checks an incoherence flag in the primary cache memory 22 prior to this access. That is, the cache control circuit 23 asserts a read enable signal RE0, and sends an index of the cache line to be accessed to the primary cache memory 22 as an index IND0. Then, the cache control circuit 23 receives an incoherence flag corresponding to index IND0 from the primary cache memory 22 as read data RD0.

Subsequently, when the incoherence flag read from the primary cache memory 22 is set, the cache control circuit 23 determines that the current access corresponds to violation access pattern 5, and asserts violation detection signal 1. The cache control circuit 23 outputs an address where the read or write access was made as violation detection address 1. These violation detection signal 1 and violation detection address 1 are sent to the violation processing circuit 16 as violation detection information 1.

On the other hand, when this incoherence flag is cleared, the cache control circuit 23 determines that the current access does not correspond to violation access pattern 5. In this case, the cache control circuit 23 does not output any violation detection information 1 to the violation processing circuit 16.

When the state of a cache line held in the primary cache memory 22 is changed to one of states 1 to 3 below, the cache control circuit 23 executes processing for clearing an incoherence flag.

(1) a state in which a new cache line is overwritten on the held cache line by the refill processing

(2) a state in which a new cache line is overwritten on the held cache line by a cache line allocation operation without refill

(3) a state in which the held cache line is invalidated by a direct rewrite operation of the primary cache memory

More specifically, the cache control circuit 23 asserts a chip enable signal CE0, and sends an index of a cache line to the primary cache memory 22 as an index IND0. The cache control circuit 23 sets “0” in a bit corresponding to a flag of write data WD0, and sends that data to the primary cache memory 22. In this way, a specific incoherence flag of the primary cache memory 22 is cleared.

As described in detail above, according to the second embodiment, an incoherence flag can be stored in the primary cache memory 22. Thus, an increase in circuit area can be suppressed compared to a case in which the incoherence flag is implemented as another memory or register. Other effects are the same as the first embodiment.

### Third Embodiment

In the second embodiment, an incoherence flag is integrated to the primary cache memory 22 by increasing the number of bits per cache line of the primary cache memory 22 by 1 bit. Alternatively, an incoherence flag can be expressed as a combination of statuses of a valid bit and dirty bit. In the third embodiment, an incoherence flag is integrated to the primary cache memory 22 without increasing the size of the primary cache memory 22.

The arrangement of the cache system 21 is the same as that shown in FIG. 7. Of the cache system 21 shown in FIG. 7, the arrangement of the primary cache memory 22 is the same as that of the primary cache memory 22 shown in FIG. 3, and does not include any flag bit used to store an incoherence flag unlike in the second embodiment.

There are the following four different combinations of the statuses of a valid bit and dirty bit stored in the primary cache memory 22. In the following description, “V” represents a valid bit, and “D” represents a dirty bit.

“V=0, D =0”: a state in which no cache line is held

“V=0, D=1”: a state in which no cache line is held

“V=1, D=0”: a state in which a non-rewritten cache line is held

“V=1, D=1”: a state in which a rewritten cache line is held

V=0 represents a state in which no cache line is held for both D=0 and D=1. By changing the state indicated when V=0 as follows, an incoherence flag is integrated to the primary cache memory 22.

“V=0, D=0”: a state in which no cache line is held

“V=0, D=1”: a state in which a non-rewritten cache line is held, and an incoherence flag is set to “1”

“V=1, D=0”: a state in which a non-rewritten cache line is held, and an incoherence flag is set to “0”

“V=1, D=1”: a state in which a rewritten cache line is held

With these settings, a state in which an incoherence flag is set or cleared can be expressed using a valid bit and dirty bit without holding a bit of the incoherence flag in another register.

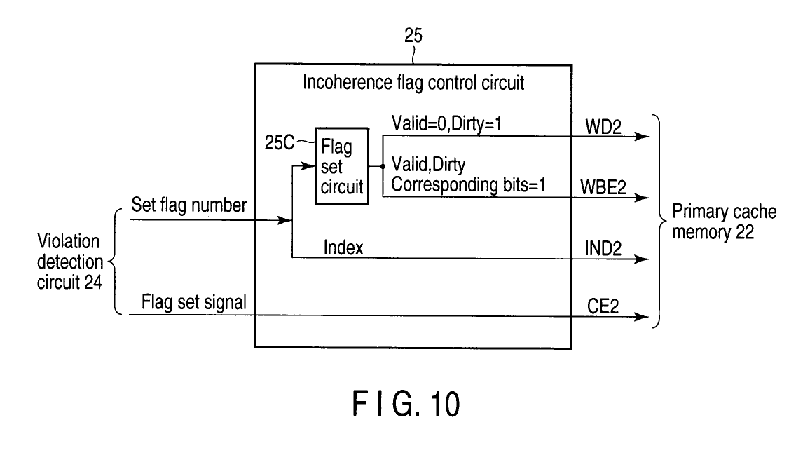

FIG. 10 is a block diagram showing the arrangement of an incoherence flag control circuit 25 according to the third embodiment of the present invention. The incoherence flag control circuit 25 includes a flag set circuit 25C.

The incoherence flag control circuit 25 receives a flag set signal and set flag number from the violation detection circuit 24. The set flag number is input to the flag set circuit 25C. The flag set circuit 25C executes processing for setting an incoherence flag in the primary cache memory 22 using a combination of a valid bit and dirty bit. To attain this processing, the flag set circuit 25C generates an enable signal used to assert a valid bit and dirty bit of the primary cache memory 22, and data to be set in the valid bit and dirty bit.

The incoherence flag control circuit 25 sends a chip enable signal CE2, write bit enable signal WBE2, index IND2, and write data WD2 to the primary cache memory 22. With these signals, an incoherence flag in the primary cache memory 22 is set.

(Operation)

The operation of the cache system 21 with this arrangement will be described below. The incoherence flag set operation by the incoherence flag control circuit 25 will be described first.

When the violation detection circuit 24 detects an access pattern for which an incoherence flag is to be set, it asserts a flag set signal. When the flag set signal is asserted, the incoherence flag control circuit 25 asserts chip enable signal CE2. Upon reception of a set flag number corresponding to an index of a cache line from the violation detection circuit 24, the incoherence flag control circuit 25 sends it as index IND2 to the primary cache memory 22 together with the flag set signal.

Upon reception of the set flag number, the flag set circuit 25C sets “1” in bits respectively corresponding to a valid bit and dirty bit in the write bit enable signal WBE2, and sends that signal to the primary cache memory 22. The flag set circuit 25C sets “0” in a bit corresponding to the valid bit and “1” in a bit corresponding to the dirty bit in write data WD2, and sends that data to the primary cache memory 22. In this way, the state of a specific cache line in the primary cache memory 22 is changed to “V=0, D=1”.

The operation of the cache control circuit 23 will be described below. When a read or write access that hits a cache line held in the primary cache memory 22 is made, the cache control circuit 23 checks an incoherence flag in the primary cache memory 22 prior to this access. That is, the cache control circuit 23 asserts a read enable signal RE0, and sends an index of the cache line to be accessed to the primary cache memory 22 as an index IND0. Then, the cache control circuit 23 receives a valid bit and dirty bit corresponding to index IND0 from the primary cache memory 22 as read data RD0.

Subsequently, when the valid bit and dirty bit read from the primary cache memory 22 are “V=0, D=1”, i.e., when an incoherence flag is set, the cache control circuit 23 determines that the current access corresponds to violation access pattern 5, and asserts violation detection signal 1. The cache control circuit 23 outputs an address where the read or write access was made as violation detection address 1. These violation detection signal 1 and violation detection address 1 are sent to the violation processing circuit 16 as violation detection information 1.

On the other hand, when this incoherence flag is cleared by the combination of the valid bit and dirty bit, the cache control circuit 23 determines that the current access does not correspond to violation access pattern 5. In this case, the cache control circuit 23 does not output any violation detection information 1 to the violation processing circuit 16.

Then, the cache control circuit 23 updates the valid bit and dirty bit to “V=1, D=0” when the current access is a read access or to “V=1, D=1” when the current access is a write access, i.e., it updates these bits to a state including no incoherence flag information. As a result, even when the next access is made to that cache line, no violation is detected.

When the state of a cache line held in the primary cache memory 22 is changed to one of states 1 to 3 below, a write access to the valid bit and dirty bit is generated.

(1) a state in which a new cache line is overwritten on the held cache line by the refill processing

(2) a state in which a new cache line is overwritten on the held cache line by a cache line allocation operation without refill

(3) a state in which the held cache line is invalidated by a direct rewrite operation of the primary cache memory

In any of states 1 to 3, the cache control circuit 23 updates the valid bit and dirty bit to a state other than “V=0, D=1”, thus returning a state equivalent to that in which an incoherence flag is set to “0”.

The third embodiment is premised on that, when a violation detection enable signal VDE is negated, all incoherence flags are not cleared, and the valid bit and dirty bit are used without switching validity or invalidity of the debug function while the cache system 21 is valid. However, by executing, with respect to all cache lines, processing for once reading and recording the contents of the primary cache memory 22, and rewriting the state of each cache line to “V=1, D=0” if the read contents indicate “V=0, D=1”, all the flags can be cleared.

As described in detail above, according to the third embodiment, an incoherence flag can be stored in the primary cache memory 22. Furthermore, since a set or cleared incoherence flag is expressed using a combination of a valid bit and dirty bit, the need for allocating a new bit for an incoherence flag in the primary cache memory 22 can be obviated. Therefore, with the arrangement of the third embodiment, an increase in circuit area can be suppressed more than the second embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multiprocessor system comprising:
a plurality of cache systems arranged in correspondence with a plurality of processor cores, and each including a cache memory which stores a cache line as a processing unit of data;
a shared memory shared by the processor cores; and
an arbiter configured to arbitrate access requests sent from the cache systems to the shared memory, and configured to send the arbitrated access request to the shared memory and the cache systems,
the cache line including line information which includes a valid bit indicating whether or not the cache line is valid, a dirty bit indicating whether or not the cache line is written back to the shared memory, and a tag as address information of the cache line, and
each of the cache systems including:
a determination circuit configured to determine an access state using the line information and the access request sent from the arbiter;
a flag circuit configured to set a flag for each cache line based on a determination result of the determination circuit; and
a control circuit configured to confirm the flag when a read access or a write access is made to a cache line held in the cache memory, and configured to detect a violation access based on the flag.

2. The system according to claim 1, wherein
the dirty bit is set when the cache line is not written back to the shared memory, and
the access request includes an identification signal used to identify that the dirty bit is set.

3. The system according to claim 2, wherein the cache system includes a detection circuit configured to detect a transition of the dirty bit before and after the cache line held in the cache memory is rewritten, and configured to generate the identification signal.

4. The system according to claim 1, wherein the flag is set when a cache line held in a first cache memory is rewritten on the shared memory or a second cache memory.

5. The system according to claim 1, wherein the control circuit clears the flag when the access state does not correspond to the violation access.

6. The system according to claim 1, wherein the flag circuit includes a register configured to store the flag.

7. The system according to claim 1, further comprising a register configured to store contents of the violation access.

8. The system according to claim 1, which further comprises a switching circuit configured to switch validity or invalidity of debugging,
wherein the cache system detects the violation access when debugging is valid, and clears all flags when debugging is invalid.

9. A multiprocessor system comprising:
a plurality of cache systems arranged in correspondence with a plurality of processor cores, and each including a cache memory which stores a cache line as a processing unit of data;
a shared memory shared by the processor cores; and
an arbiter configured to arbitrate access requests sent from the cache systems to the shared memory, and configured to send the arbitrated access request to the shared memory and the cache systems,
the cache line including line information which includes a valid bit indicating whether or not the cache line is valid, a dirty bit indicating whether or not the cache line is written back to the shared memory, a tag as address information of the cache line, and a flag used to determine a violation access, and
each of the cache systems including:
a determination circuit configured to determine an access state using the line information and the access request sent from the arbiter;
a flag circuit configured to set the flag based on a determination result of the determination circuit; and
a control circuit configured to confirm the flag when a read access or a write access is made to a cache line held in the cache memory, and configured to detect the violation access based on the flag.

10. The system according to claim 9, wherein
the dirty bit is set when the cache line is not written back to the shared memory, and
the access request includes an identification signal used to identify that the dirty bit is set.

11. The system according to claim 10, wherein the cache system includes a detection circuit configured to detect a transition of the dirty bit before and after the cache line held in the cache memory is rewritten, and configured to generate the identification signal.

12. The system according to claim 9, wherein the flag is set when a cache line held in a first cache memory is rewritten on the shared memory or a second cache memory.

13. The system according to claim 9, wherein the control circuit clears the flag when the access state does not correspond to the violation access.

14. The system according to claim 9, further comprising a register configured to store contents of the violation access.

15. The system according to claim 9, which further comprises a switching circuit configured to switch validity or invalidity of debugging,
wherein the cache system detects the violation access when debugging is valid, and clears all flags when debugging is invalid.

16. A multiprocessor system comprising:
a plurality of cache systems arranged in correspondence with a plurality of processor cores, and each including a cache memory which stores a cache line as a processing unit of data;
a shared memory shared by the processor cores; and
an arbiter configured to arbitrate access requests sent from the cache systems to the shared memory, and configured to send the arbitrated access request to the shared memory and the cache systems,
the cache line including line information which includes a valid bit indicating whether or not the cache line is valid, a dirty bit indicating whether or not the cache line is written back to the shared memory, and a tag as address information of the cache line, and
each of the cache systems including:
a determination circuit configured to determine an access state using the line information and the access request sent from the arbiter;
a first control circuit configured to temporarily rewrite a valid bit and a dirty bit so as to use the valid bit and the dirty bit as a flag indicating a determination result of the determination circuit; and
a second control circuit configured to confirm the flag when a read access or a write access is made to a cache line held in the cache memory, and configured to detect a violation access based on the flag.

17. The system according to claim 16, wherein
the dirty bit is set when the cache line is not written back to the shared memory, and
the access request includes an identification signal used to identify that the dirty bit is set.

18. The system according to claim 17, wherein the cache system includes a detection circuit configured to detect a transition of the dirty bit before and after the cache line held in the cache memory is rewritten, and configured to generate the identification signal.

19. The system according to claim 16, wherein the flag is set when a cache line held in a first cache memory is rewritten on the shared memory or a second cache memory.

20. The system according to claim 16, wherein the second control circuit updates the valid bit and the dirty bit when the access state does not correspond to the violation access.
